(19) United States
(12) Patent Application Publication
(10) Pub. No.: US 2024/0421401 A1
(43) Pub. Date: Dec. 19, 2024

(54) Method for Producing an Energy Store, Energy Store and Device

(71) Applicant: Bayerische Motoren Werke Aktiengesellschaft, Muenchen (DE)

(72) Inventor: Torsten FRANKE, Muenchen (DE)

(21) Appl. No.: 18/702,351

(22) PCT Filed: Sep. 23, 2022
(86) PCT No.: PCT/EP2022/076489

§ 371 Date: Apr. 18, 2024

(30) Foreign Application Priority Data
Oct. 21, 2021 (DE) 10 2021 127 278.5

(51) Int. Cl. H01M 50/244; H01M 50/249; H01M 50/256

(52) U.S. Cl. CPC H01M 50/244; H01M 50/249; H01M 50/256

(57) ABSTRACT

A method for producing an energy store for a motor vehicle, including providing a plurality of energy storage cells, arranging the energy storage cells on or at a carrier, positioning the carrier above a target structure, the target structure extending in an xy-plane, and arranging the energy storage cells in the z-direction on or in the target structure, in particular by opening or releasing the carrier at least in some regions or sections.

### BACKGROUND AND SUMMARY

The present invention relates to a method for producing an energy storage unit, to an energy storage unit and to a device.

Energy storage units, or in particular high-voltage storage units, of the kind in question are used in partially and fully electrically operated motor vehicles. They are very large components that comprise a large number of energy storage cells. In the case of passenger vehicles, the housings of such energy storage units often take up large parts of the underbody. The production of such storage units proves to be extremely complex, in particular including due to the large number of energy storage cells that are installed in the high-voltage storage units.

One object of the present invention is therefore to specify a method for producing an energy storage unit, an energy storage unit and a device for performing the method, the method being intended to be distinguished in particular in terms of its flexibility and simplicity.

This object is achieved by a method, an energy storage unit, and a device according to the present disclosure. Further advantages and features will also become apparent from the description and the accompanying figures.

According to the invention, a method for producing an energy storage unit, in particular a high-voltage storage unit, for a motor vehicle comprises the following steps:
providing a multiplicity of energy storage cells;
arranging the energy storage cells on a carrier;
positioning the carrier above a target structure, wherein the target structure extends in an xy plane;
arranging the energy storage cells on or in the target structure in the z direction, that is to say along the height axis, in particular by opening or releasing the carrier at least in regions or sections.

According to one preferred embodiment, the energy storage cells are round cells. As an alternative, the energy storage cells may however also have another housing shape, for example a prismatic housing shape. Advantageously, the energy storage cells are arranged on the carrier, which is positioned above or on top of the target structure. From there, the energy storage cells are arranged on or in the target structure in the z direction. In this case, the energy storage cells may be arranged on or in the target structure individually, in groups or all together.

The target structure extends in the xy plane, to which the abovementioned z axis is perpendicular. The target structure may be a flat structure—for example a plate-shaped element—that has an extent essentially in the x and y direction. As an alternative, the target structure may also be a spatial structure that additionally has an extent along the z direction.

According to one embodiment, a housing component of the energy storage unit forms the target structure. The abovementioned housing component may be a housing upper part, a housing lower part or a frame element of the energy storage unit, with the above list expressly not being understood to be exhaustive.

According to one preferred embodiment, the energy storage cells are positioned on the carrier. The carrier preferably has a baseplate that is mounted so as to be able to move, such that one or more energy storage cells are able to be released in the z direction. According to one embodiment, the carrier has a frame. The abovementioned baseplate is mounted therein, for example so as to be able to move. When the baseplate is moved, one or more openings are released in the z direction, such that one or more energy storage cells are able to be shifted in the direction of the target structure.

As an alternative, the energy storage cells are positioned on the carrier. The carrier is in this case, according to one embodiment, designed in the manner of a gripping device that is configured to grip or to hold one or more energy storage cells, in particular from above. While the energy storage cells, in the case of the abovementioned carrier, are standing on the carrier, in the solution mentioned here, the energy storage cells are held, in particular actively, above the carrier, which to this end preferably has corresponding means for gripping/holding the energy storage cells. The abovementioned means are expediently configured to be able to release the energy storage cells such that they are able to be placed on or in the target structure.

According to one preferred embodiment, the method comprises the following steps:
positioning the carrier on the energy storage cells;
turning the carrier together with the energy storage cells, such that the energy storage cells are arranged on the first carrier.

Advantageously, the method may comprise turning the energy storage cells. This advantageously makes it possible to optimize the accessibility of the cells. This expediently makes it possible for example to treat the energy storage cells from multiple sides/directions, in particular both from above and from below.

Lateral treatment is made possible in particular by sequentially shifting the energy storage cells in the z direction. As mentioned, these may be shifted individually or in groups/rows in succession in the z direction, as a result of which, each time energy storage cells are “let out”, “new” energy storage cells become laterally accessible.

The multiplicity of energy storage cells is preferably provided in “standing” form. The energy storage cells are expediently arranged here with a regular repetition, for example in a matrix pattern, in particular in a pack pattern. Depending on how the energy storage cells are provided, following the mentioned turning, they are oriented “incorrectly” or the wrong way round, for example their lower side is pointing upward. It should however be taken into consideration here that the target structure may advantageously also be turned, as explained in more detail later, such that the final orientation is automatically correct.

As an alternative, the energy storage cells may also be turned multiple times using corresponding carriers.

The method may expediently accordingly comprise using more than one carrier, for example using a second carrier, etc. in addition to a first carrier. It should be mentioned here that a carrier does not necessarily have to be used to turn the energy storage cells.

According to one embodiment, the method comprises the following step:
changing or adapting an orientation of the energy storage cells with respect to one another indirectly using the one or more carriers.

Expediently, at least one carrier comprises means for positioning the energy storage cells or orienting them with respect to one another, that is to say in particular within the xy plane. According to one embodiment, at least one carrier comprises receptacles for the energy storage cells that serve to position the energy storage cells on the carriers. In this case, the receptacles of different carriers may be designed differently. It is thereby possible to change the positioning or orientation of the energy storage cells with respect to one another, in particular preferably to adapt same to a pattern of the target structure.

According to one embodiment, the method comprises the following steps:
treating one or more energy storage cells in each case before and/or after the turning.

As already mentioned, turning in particular enables better accessibility of the energy storage cells. The sequential shifting of the energy storage cells in the z direction also advantageously enables accessibility to be optimized, since the side surfaces of the energy storage cells are progressively released and are thereby accessible.

According to one embodiment, the treatment comprises at least one of the following steps:
cleaning, in particular plasma-cleaning, at least one region of an energy storage cell;
connecting a monitoring unit, monitoring electronics;
interconnecting the energy storage cells;
identifying the energy storage cells;
testing properties of the energy storage cells, in particular for quality control purposes.

The treatment is possible regardless of whether or not turning is performed.

According to one embodiment, the method comprises the following steps:
providing the energy storage cells in a transport unit;
opening the transport unit in order to expose at least regions of the energy storage cells;
treating the energy storage cells.

The energy storage cells, preferably round cells, are expediently oriented so as to be standing, along their height direction, in the transport unit.

The transport unit may also be referred to as a packaging unit in which the energy storage cells are transported within a factory or supplied by a supplier. The transport unit is first opened, wherein first treatment steps are expediently already performed here, such as for example a test to identify defective cells and plasma-cleaning of the cells in the open region of the transport/packaging unit. The cells are expediently arranged with a regular repetition in the transport unit. After the transport unit has been opened on the upper side, the steps of part identification, entry inspection and surface treatment of the exposed surface may expediently be performed for all of the cells.

According to one preferred embodiment, the method in particular furthermore comprises the following steps:
arranging a first carrier on the energy storage cells;
turning the first carrier together with the energy storage cells, such that the energy storage cells are positioned on the first carrier;
arranging the energy storage cells on a second carrier in the z direction;
arranging the energy storage cells on a housing component in the z direction.

In this embodiment, two carriers are expediently used, these being carriers that are preferably equipped with the abovementioned baseplates. These allow the targeted release of one or more energy storage cells in the z direction.

Expediently, after the first carrier has been turned together with the energy storage cells, the transport unit is completely removed. This may then expediently be followed by further treatment steps, such as for example further plasma-cleaning, a further test to identify defective cells, etc. Work may be performed here for example using a needle probe. The shifting of the energy storage cells onto the second carrier may expediently be combined with further treatment steps, such as for example further cleaning steps.

According to one preferred embodiment, energy storage cells that have been recognized as defective are exchanged for functioning cells at the latest after the energy storage cells have been arranged on the second carrier, both expediently in the vertical direction, in other words along the z axis. It should be mentioned here that the pattern of the energy storage cells with respect to one another is expediently not changed throughout the method. Although the distance between the energy storage cells in the xy plane may be changed, as mentioned, the relative positioning is maintained, thereby ensuring optimum traceability.

When the energy storage cells are placed on the for example second carrier—or generally on a further carrier-according to one embodiment, the energy storage cells may be reoriented with respect to one another. This means that a distance between the energy storage cells may be reduced or increased, in particular to adapt it to the distance/the pattern that the energy storage cells have with respect to one another on or in the target structure. In this case, the receptacle in the carrier may have corresponding guides that are configured to orient the energy storage cells along the z direction during movement. As an alternative, the carrier may have corresponding means in order to position, in particular to move, the energy storage cells thereon.

Expediently, the method comprises the following step:
using assistive elements to arrange the energy storage cells in the z direction, in particular by influencing the movement of the energy storage cells,

Expediently, the assistive elements are intended to lower the energy storage cells, in particular in a controlled manner, onto the target structure, preferably onto a carrier or onto/into a housing component, in the z direction. This should also be understood to mean that it is possible to actively support, that is to say in particular also speed up, the lowering of the energy storage cells in the z direction. By way of example, supports or the like, which are able to be moved in the z direction, may be used as assistive elements.

According to one preferred embodiment, the target structure is a housing component, in particular a frame element, comprising a multiplicity of openings extending along the z direction, wherein each opening is intended for the arrangement of an energy storage cell. The openings are expediently open at the top and at the bottom, such that support elements designed as assistive elements are able to be inserted from one side (for example from below) and are able to support the energy storage cells coming from the other side (from above) in the z direction or to be used to let these out in the z direction.

According to one embodiment, the abovementioned openings in the frame element taper conically toward one another along the z direction, thereby expediently achieving positioning and also fastening of the energy storage cells in the target structure.

According to one embodiment, the method furthermore comprises the following steps:
arranging a housing lower part, in particular from above, on the frame element;
turning the arrangement, comprising the frame element, the energy storage cells arranged therein and the housing lower part;
arranging the housing upper part, in particular from above.

Prior to the arrangement of the housing lower part, further treatment steps, such as welding operations, etc. may expediently be performed. Following the turning and expediently prior to the arrangement of the housing upper part, a cell contact system is arranged and interconnected, sensors are installed, any insulation work is carried out, etc. According to one embodiment, prior to the arrangement of the housing upper part and the housing lower part, the gaps between the cells and/or the frame element are filled with a potting compound.

According to one preferred embodiment, the method comprises the following step:
adjusting the cell positions by way of a hold-down clamp during the treatment of the energy storage cells.

According to one embodiment, a hold-down clamp is used during the welding/interconnection of the energy storage cells, in particular preferably even prior to the arrangement of the housing lower part.

Provision is expediently made for an end inspection as a further treatment step.

The invention also relates to an energy storage unit, in particular a high-voltage storage unit, for a motor vehicle, which is produced in accordance with the method according to the invention. Motor vehicles in this case are in particular passenger vehicles, motorcycles or utility vehicles.

According to one preferred embodiment, the energy storage unit comprises a frame element in which the energy storage cells are arranged in a form-fitting manner. The energy storage cells are expediently positioned exactly in the xy plane by virtue of the form fit. The frame element is in this case expediently designed such that each energy storage cell is contacted approximately over its whole surface or preferably over its whole circumference, thereby making it possible to achieve optimum thermal conduction. Preferred materials for the frame are plastic or else metal materials or a combination of the abovementioned materials. In one corresponding design of the frame, it is also possible to enable positioning of the energy storage cells in the z direction, for example using openings that taper conically toward one another.

The invention furthermore relates to a device for performing the method according to the invention, comprising one or more carriers. The carriers are expediently configured to arrange and position the energy storage cells in the z direction. It is possible to work with one or more carriers here. Expediently, at least one carrier comprises receptacles for the energy storage cells that correspond to the position of the cells in the transport unit. A second carrier may, with regard to the layout of the receptacle for the cells, already be adapted in part or in full to the layout of the target structure to be populated, such as for example the frame element of the energy storage unit. In addition or as an alternative, at least one carrier may have a device for the xy movement of the energy storage cells.

Further advantages and features will become apparent from the following description of one embodiment of the method or of an energy storage unit and of a device with reference to the accompanying figures.

### BRIEF DESCRIPTION OF THE DRAWINGS

FIG. 1 shows the provision of a multiplicity of energy storage cells in a transport unit;

FIG. 2 shows the arrangement of a first carrier on a transport unit;

FIG. 3 shows the arrangement known from FIG. 2 after turning;

FIG. 4 shows the shifting of the energy storage cells from the first carrier onto a second carrier in the z direction;

FIG. 5 shows the replacement of a defective energy storage cell;

FIG. 6 shows the arrangement of the energy storage cells in a target structure;

FIG. 7 shows the arrangement of a housing lower part;

FIG. 8 shows the arrangement of a housing upper part.

### DETAILED DESCRIPTION OF THE DRAWINGS

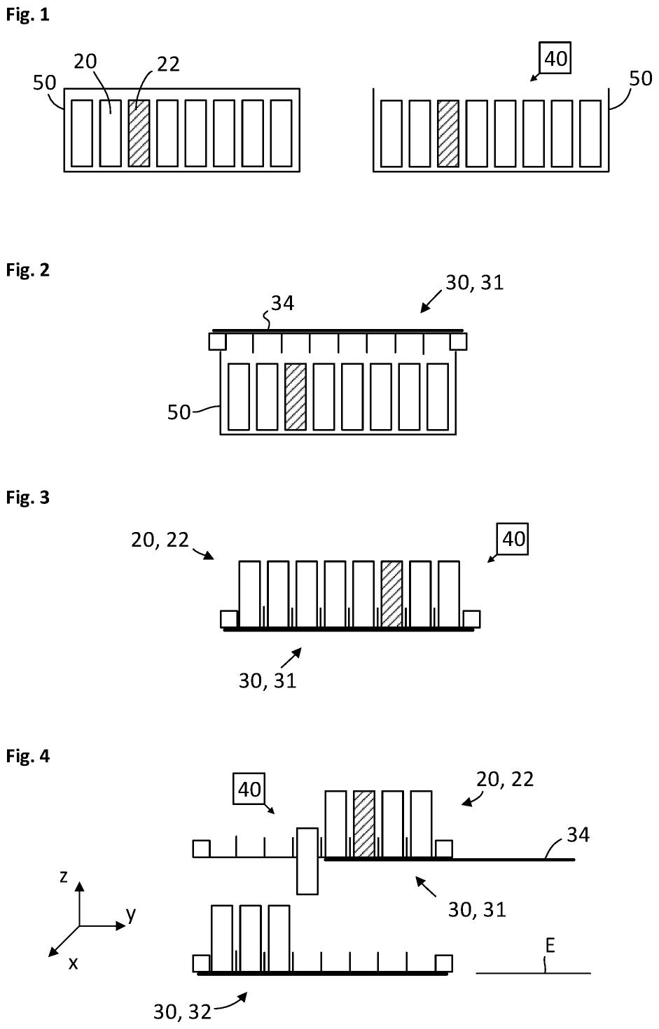

FIG. 1 shows a schematic view of a transport unit 50 in which a multiplicity of energy storage cells 20 is arranged. The transport unit 50 may also be referred to as a packaging unit. The energy storage cell, illustrated in hatched form, is a defective energy storage cell; cf. reference sign 22. The right-hand half of the image illustrates that the packaging or transport unit 50 is at least partially removed. In particular, a cover is removed by way of example. Reference sign 40 is used to illustrate that first treatment steps may already be performed at this time. According to one embodiment, for example, the energy storage cells, where accessible, are plasma-cleaned. Tests may additionally be performed, such as for example in order to identify defective energy storage cells. As sketched here, it may already be known even before the test for defective energy storage cells that a defective energy storage cell is present in the transport unit 50. Since the position of the cells with respect to one another is not changed, optimum traceability is ensured throughout the entire method.

FIG. 2 schematically shows the arrangement of a first carrier 31 on the transport unit 50. The first carrier 31 in this case comprises a baseplate 34, which is intended subsequently to release the energy storage cells 20 in the z direction. It is schematically illustrated that the carrier 31 has a receptacle that serves to position the energy storage cells with respect to one another. After the carrier 31 has been arranged on the transport unit 50, the entire arrangement is turned; cf. FIG. 3.

FIG. 3 shows the arrangement, essentially known from FIG. 2, after turning, that is to say following a rotation by 180°. The energy storage cells 20 are now arranged on the first carrier 31. The transport unit 50 is removed completely. Reference sign 40 again indicates that further treatment steps may take place at this time, such as for example further cleaning steps, test steps, identification steps, etc.

FIG. 4 shows the shifting of the energy storage cells 20 from the first carrier 31 onto a second carrier 32. An xyz coordinate system is illustrated for orientation purposes. The second carrier 32 may also be referred to as a target structure, with this extending within an xy plane E. Expediently, an arrangement takes place in each case on or possibly also in a target structure along the z direction. The energy storage cells 20 may each be shifted individually, simultaneously in groups or all together in the z direction.

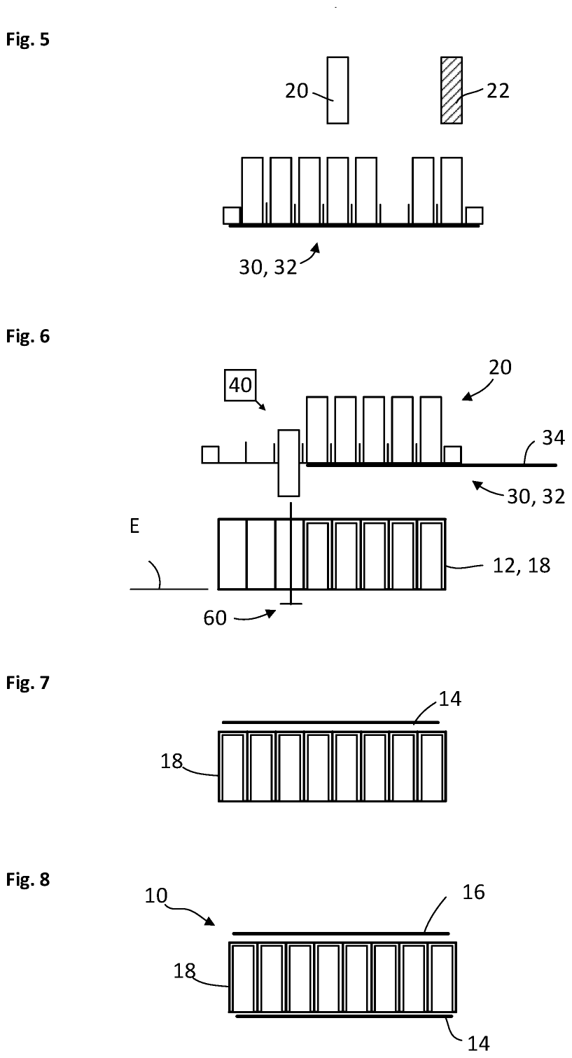

FIG. 5 schematically shows the exchanging of the defective energy storage cell 22 for a functional energy storage cell 20.

FIG. 6 shows the arrangement of the energy storage cells from the second carrier 32 in a housing component 12, here a frame element. In the embodiment shown here, the second carrier accordingly does not yet constitute the target structure. This is expediently formed here by the frame element 18. The arrangement itself follows the known scheme along the z direction. A support element 60 is illustrated schematically and is intended to support the arrangement of the energy storage cell 20 in the z direction, in particular for example to brake it or to accelerate it.

FIG. 7 schematically shows the arrangement of a housing lower part 14 on the frame element 18. The frame element 18 and also the housing lower part 14 are then expediently rotated.

FIG. 8 shows the arrangement of a housing upper part 16 to complete the energy storage unit 10. Required steps, such as interconnecting the energy storage cells, arranging a cell contact system, etc. are not illustrated in more detail.

### LIST OF REFERENCE SIGNS

10 energy storage unit, high-voltage storage unit
12 housing component
14 housing lower part
16 housing upper part
18 target structure, frame element
20 energy storage cell
22 defective energy storage cell
30 carrier
31 first carrier
32 second carrier
34 baseplate
40 treatment step
50 transport unit
60 support element
E xy plane
x, y, z coordinate system

1-15. (canceled)

16. A method for producing an energy storage unit for a motor vehicle, comprising:
providing a plurality of energy storage cells;
arranging the plurality of energy storage cells on a carrier;
positioning the carrier above a target structure, wherein the target structure extends in an xy plane; and
arranging the energy storage cells on or in the target structure in a z direction by opening or releasing the carrier at least in regions or sections.

17. The method according to claim 16,
wherein a housing component of the energy storage unit forms the target structure.

18. The method according to claim 16,
wherein the or a carrier has a baseplate that is mounted so as to be able to move, as a result of which one or more energy storage cells are able to be released in the z direction.

19. The method according to claim 16, comprising:
positioning the carrier on the plurality of energy storage cells; and
turning the carrier together with the plurality of energy storage cells, such that the plurality of energy storage cells are arranged on the carrier.

20. The method according to claim 16, comprising:
changing or adjusting an orientation of the energy storage cells with respect to one another indirectly using the carrier.

21. The method according to claim 19, comprising:
treating one or more energy storage cells in each case before and/or after the turning.

22. The method according to claim 21, wherein the treating comprises at least one of the following:
plasma-cleaning at least a region of an energy storage cell;
connecting a monitoring unit/monitoring electronics;
interconnecting the energy storage cells;
identifying the energy storage cells; and/or
testing properties of the energy storage cells.

23. The method according to claim 16, comprising:
providing the plurality of energy storage cells in a transport unit;
opening the transport unit in order to expose at least regions of the plurality of energy storage cells; and
treating the plurality of energy storage cells.

24. The method according to claim 23, comprising:
arranging a first carrier on the plurality of energy storage cells;
turning the first carrier together with the plurality of energy storage cells, such that the plurality of energy storage cells are positioned on the first carrier;
arranging the plurality of energy storage cells on a second carrier in the z direction; and
arranging the plurality of energy storage cells in or on the target structure in the z direction.

25. The method according to claim 16, comprising:
replacing at least one energy storage cell while maintaining a position of the at least one energy storage cells with respect to another at least one energy storage cell.

26. The method according to claim 16, comprising:
using assistive elements to arrange the energy storage cells in the z direction by influencing a movement of the energy storage cells.

27. The method according to claim 23,
wherein the target structure is a frame element,
the method comprising:
arranging a housing lower part on the frame element;
turning the frame element and the plurality of energy storage cells; and
arranging a housing upper part.

28. An energy storage unit for a motor vehicle, produced according to the method according to claim 16.

29. The energy storage unit according to claim 28, comprising:
a frame element in which the plurality of energy storage cells are arranged in a form-fitting manner.

30. A device for performing a method according to claim 16, comprising one or more carriers.
